(19) United States
(12) Patent Application Publication
(10) Pub. No.: US 2005/0135364 A1
(43) Pub. Date: Jun. 23, 2005

(54) Communication method and apparatus using multicast address

(76) Inventor: Byoung-yue Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/937,283

(22) Filed: Sep. 10, 2004

(30) Foreign Application Priority Data
Dec. 17, 2003 (KR) 2003-92586

(51) Int. Cl. H04L 12/28

(52) U.S. Cl. 370/390

(57) ABSTRACT

Provided is a method and apparatus for one-to-one communication between network devices using a multicast address generated from a media access control address by the network devices. The communication method uses a first multicast address and a second multicast address by generating the first multicast address using a first media access control address unique to a first network device connected to a network and the second multicast address using a second media access control address unique to a second network device connected to the network. The method includes generating the first multicast address from the first media access control address unique to the first network device, generating the second multicast address from the second media access control address unique to the second network device, generating a packet by the first network device and transmitting the packet to the second network device with the second multicast address, and generating a response packet by the second network device that receives the packet and transmitting the response packet to the first network device with the first multicast address.

### CROSS-REFERENCE TO RELATED APPLICATIONS

This application claims the benefit under 35 U.S.C.§119(a) of Korean Patent Application No. 2003-92586, filed on Dec. 17, 2003, in the Korean Intellectual Property Office, the disclosure of which is incorporated herein in its entirety by reference.

### BACKGROUND OF THE INVENTION

1. Field of the Invention

The present invention relates to a communication method and apparatus using a multicast address. More particularly, the present invention relates to a method and apparatus for one-to-one communication between network devices using a multicast address generated from a media access control address by the network devices.

2. Description of the Related Art

Generally, Internet protocol (IP) communications require IP addresses, subnet masks, and gateway addresses of network devices. In other words, IP communication between specific network devices is not possible before a network device is granted an IP address that enables it to communicate with other network devices, a subnet mask, and a gateway address by a system administrator or a dynamic host configuration protocol (DHCP) server.

IP communication is possible without the IP address using a broadcasting method or a multicasting method, however, it increases overall network traffic and the communication is received by all network devices. Therefore, such methods may be suitable for the transmission of a small volume of data but not for the transmission of a large volume of data.

FIG. 1 illustrates data transmission between network devices without IP addresses, using the broadcasting method or the multicasting method. Referring to FIG. 1, a first network device 100, a second network device 110, a third network device 120, and a fourth network device 130 are connected to a network 160.

For example, it is assumed that the first network device 100 transmits inquiry data to the third network device 120, which then transmits response data to the first network device 100.

The first network device 100 uses the broadcasting or the multicasting method to transmit the inquiry data through the network 160. The first network device 100 transmits the inquiry data to the second network device 110, the third network device 120, and the fourth network device 130 connected to the network 160 through a path 140. Then, the second network device 110 and the fourth network device 130 discard the inquiry data that is irrelevant to them, while the third network device 120 transmits the response data to the first network device 100, the second network device 110, and the fourth network device 130 connected to the network 160 through a path 150. The second network device 110 and the fourth network device 130 discard the response data that is irrelevant to them, while the first network device 100 receives the response data.

As described above, the broadcasting or the multicasting method may be useful for network devices without IP addresses to communicate with one another. However, when using the broadcasting or the multicasting method, not only the first network device 100 and the third network device 120 that are relevant to the data transmission, but also the second network device 110 and the fourth network device 130 that are irrelevant are affected by the data transmission. Consequently, traffic to all of the network devices 100, 110, 120, and 130 connected to the network 160 increases. In this regard, the broadcasting or the multicasting method is not suitable for a large volume of data.

### SUMMARY OF THE INVENTION

The present invention provides a method and apparatus for one-to-one communication between network devices using a multicast address generated by the network devices out of a media access control address.

According to an aspect of the present invention, there is provided a communication method using a first multicast address and a second multicast address by generating the first multicast address using a first media access control address unique to a first network device connected to a network and the second multicast address using a second media access control address unique to a second network device connected to the network. The method includes generating the first multicast address from the first media access control address unique to the first network device. The second multicast address is generated from the second media access control address unique to the second network device. Then, a packet is generated by the first network device, which transmits the packet to the second network device with the second multicast address. The second network device that receives the packet generates a response packet and transmits it to the first network device with the first multicast address.

The packet may include at least the first media access control address, the second media access control address, and the second multicast address. The response packet may include at least the first media access control address, the second media access control address, and the first multicast address.

The generation of a response packet by the second network device that receives the packet and transmitting the response packet to the first network device with the first multicast address may include determining whether the second media access control address included in the received packet matches the second media access control address unique to the second network device. The second network device processes the received packet when the second media access control address included in the received packet matches the second media access control address unique to the second network device. The response packet is generated and transmitted to the first network device with the first multicast address.

The determination of whether the second media access control address included in the received packet matches the second media access control address unique to the second network device may include extracting the second media access control address from the received packet and determining whether the extracted second media access control address matches the second media access control address unique to the second network device.

The generation of a packet by the first network device and transmission of the packet to the second network device with the second multicast address may include generating the packet by the first network device and transmitting the packet to the second network device with the second multicast address. The first network device, when generating a packet may also determine whether the first media access control address included in the response packet received from the second network device matches the first media access control address unique to the first network device. The first network device also receives the response packet when the first media access control address included in the received response packet matches the first media access control address unique to the first network device.

The determination of whether the first media access control address included in the response packet received from the second network device matches the first media access control address unique to the first network device may include extracting the first media access control address from the received response packet; and determining whether the extracted first media access control address matches the first media access control address unique to the first network device.

According to another aspect of the present invention, there is provided a communication apparatus using a first multicast address and a second multicast address by generating the first multicast address using a first media access control address unique to a first network device connected to a network. The second multicast address using a second media access control address unique to a second network device connected to the network. The method includes the first network device generating a packet and transmitting the packet to the second network device with the second multicast address. The method also included the second network device receiving the packet and transmitting the response packet to the first network device with the first multicast address.

The first network device may include a media access control address designator, a multicast address generator, a packet generator, a packet transceiver, and a media access control comparator. The media access control address designator designates the second media access control address unique to the second network device. The multicast address generator generates the second multicast address of the second network device that receives the packet. The packet generator comprises at least the first media access control address, the second media access control address, and the second multicast address. The packet transceiver transmits the packet generated by the packet generator to the second network device with the second multicast address and receives the response packet transmitted from the second network device. The media access control comparator extracts the first media access control address from the received response packet and compares the extracted first media access control address with the first media access control address unique to the first network device to determine whether they match.

The multicast address generator may generate the second multicast address from the second media access control address.

The second network device, like the first, may include a media access control address designator, a multicast address generator, a packet generator, a packet transceiver, and a media access control comparator. The media access control address designator designates a first media access address unique to the first network device. The multicast address generator generates the first multicast address of the first network device receiving the response packet. The packet generator comprises at least the first media access control address, the second media access control address, and the first multicast address. The packet transceiver transmits the packet generated by the packet generator to the second network device with the second multicast address and receives the response packet transmitted from the second network device. The media access control comparator extracts the second media access control address from the received packet and compares the extracted second media access control address with the second media access control address unique to the second network device to determine whether they match.

The multicast address generator may generate the second multicast address from the second media access control address.

As described above, in an embodiment of the present invention, a network device generates a multicast address from a media access control address and performs a one-to-one communication using the multicast address, thereby reducing network traffic.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates data transmission between network devices without Internet protocol (IP) addresses using a broadcasting method or a multicasting method;

FIG. 2 is a block diagram of a network device according to an embodiment of the present invention;

FIG. 3 is a flow chart illustrating a method of transmitting a packet from a first network device to a second network device according to an embodiment of the present invention;

FIG. 4 is a flow chart illustrating a method of transmitting a response packet from a second network device to a first network device according to an embodiment of the present invention;

FIG. 5 illustrates a media access control (MAC) address and its corresponding multicast address according to an embodiment of the present invention;

FIG. 6 illustrates the structure of a packet according to an embodiment of the present invention;

FIG. 7 illustrates the structure of packets transmitted and received according to an embodiment of the present invention; and

FIG. 8 illustrates the structures of packets transmitted between a trivial file transfer protocol (TFTP) server and a TFTP client according to an embodiment of the present invention.

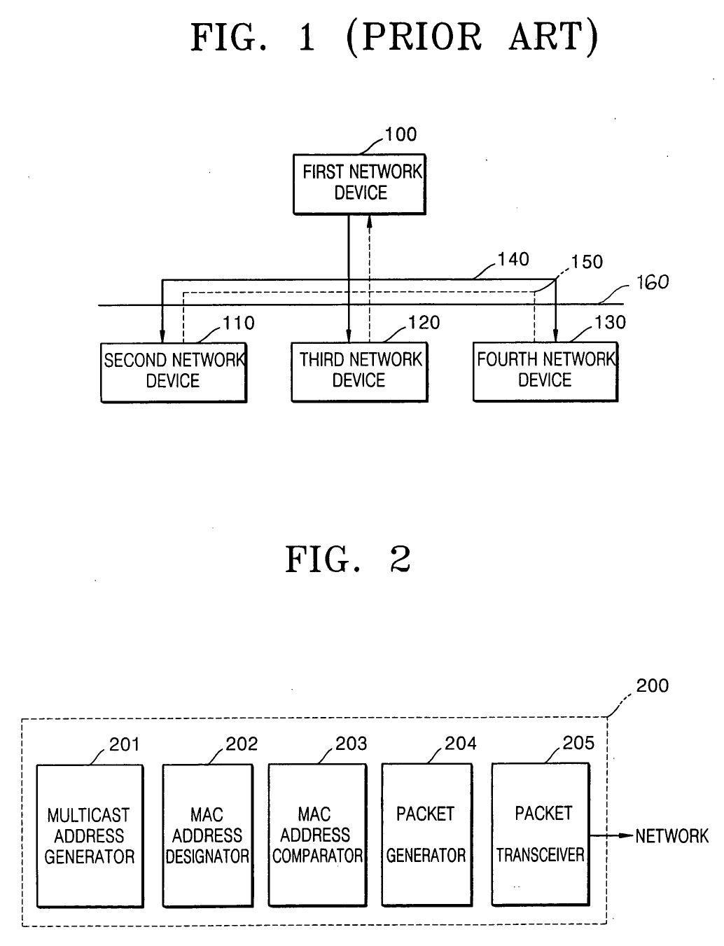

It is understood that like reference numerals in the drawings denote like elements and structures, and thus their description will be omitted.

### DETAILED DESCRIPTION OF THE EXEMPLARY EMBODIMENTS

Embodiments of the present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

FIG. 2 is a block diagram of a network device 200 according to an embodiment of the present invention. The network device 200 includes a multicast address generator 201, a media access control (MAC) address designator 202, a MAC address comparator 203, a packet generator 204, and a packet transceiver 205. A transmitting network device (a first network device) and a receiving network device (a second network device) may have the same configuration as the network device 200.

Referring to FIG. 2, the multicast address generator 201 generates a multicast address using a MAC address unique to each network device.

Generally, IP addresses are divided into network IDs and host IDs. Network IDs are addresses of networks, and the host IDs are addresses of individual hosts. IP addresses use five network classes A, B, C, D, and E, which are classified according to the length of network addresses. Class D is reserved for IP multicasting, and class E is reserved for experimental purposes. Hence, only the classes A, B, and C may be used to assign addresses for general purposes.

A 32-bit IP address for IP multicasting is divided into a high order bit determining a network class internally, a network address, and a host address. As for class D, of the 32 bits, five high order bits are set to “11110.” Therefore, a first value of the IP address ranges from 224 to 239. Accordingly, the scope of a multicast address should be between 224.0.0.0 and 239.255.255.255. To avoid addresses used especially for multicasting, for example, 224.0.0.1, 224.0.0.2, 224.0.1.1, and 224.0.0.9, the first value of the IP address should be set to 255, and remaining three low bytes should be calculated.

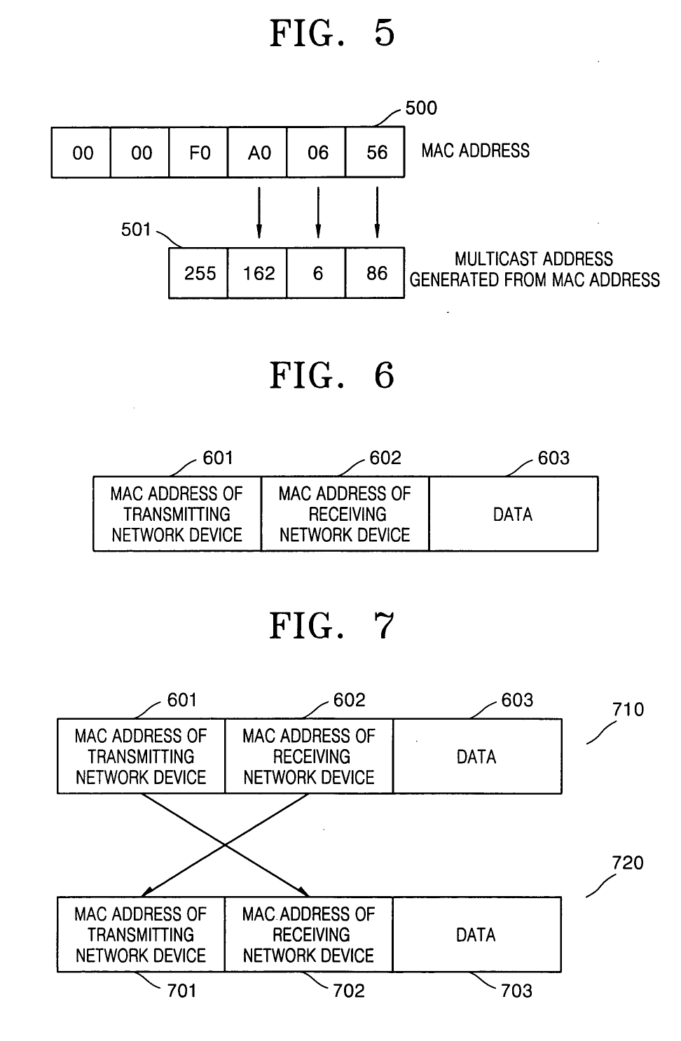

When a MAC address of a network device is 00:00:F0:A0:06:56, a multicast address generated from the MAC address is 225.160.6.86. The multicast address generated from the MAC address is illustrated in FIG. 5.

FIG. 5 illustrates a media access control (MAC) address and its corresponding multicast address according to an embodiment of the present invention. Referring to FIG. 5, reference numeral 500 indicates the MAC address unique to the network device, and reference numeral 501 indicates the multicast address generated from the MAC address 500.

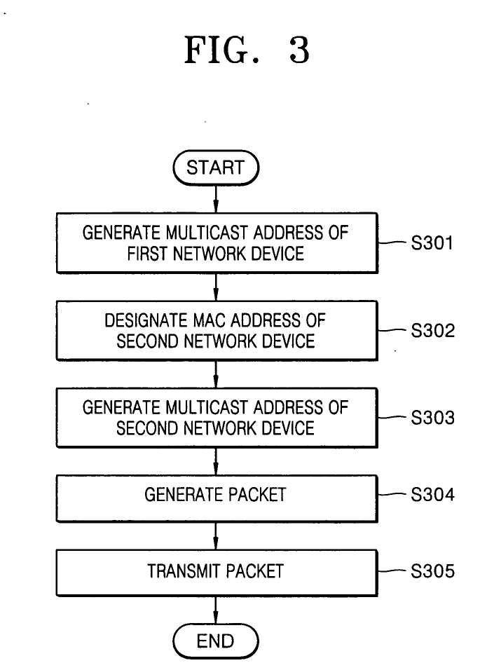

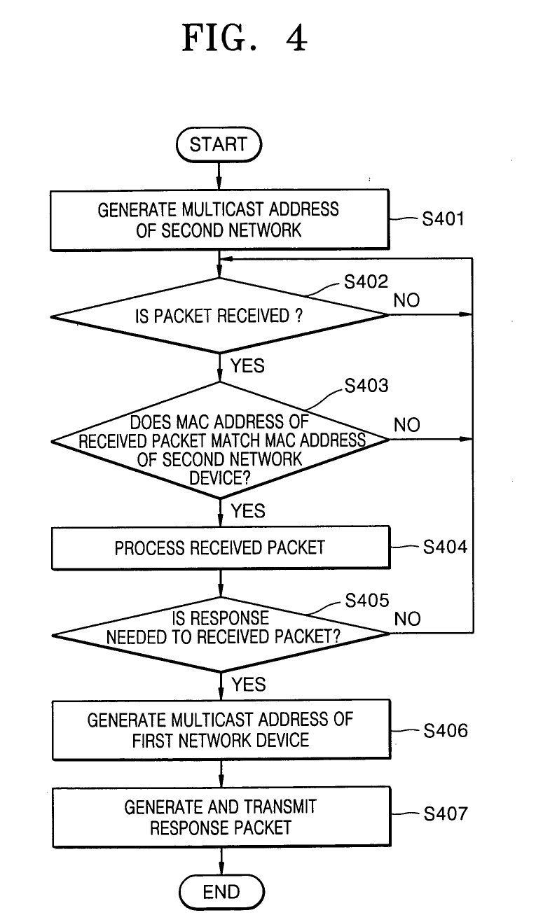

When the three low order bytes of MAC addresses are identical, for example, 00:00:F0:A0:06:56 and 00:00:F1:A0:06:56, an identical multicast address is generated, for example, 225.162.6.86. The resultant collisions will be described later with reference to FIGS. 3 and 4.

The MAC address designator 202 designates a MAC address of a target network device of communication. According to embodiments of the present invention, the MAC address of the target network device is defined in advance to enable one-to-one IP communications between network devices using the multicasting method. Alternatively, the MAC address of the target network device may be selected from MAC addresses retrieved from the network. The MAC addresses may be retrieved from the network using the conventional multicasting method or the broadcasting method, or by the following method.

All network devices according to embodiments of the present invention basically have a common multicast address, for example, 224. 224. 224. 224, to retrieve the MAC address of the target network device. Although the transmitting network device does not specify the MAC address of the receiving network device, the receiving network device defines a common MAC address (FF: FF: FF: FF: FF: FF) by which a packet can be received. Hence, a channel through which the packet can be transmitted even without the MAC address of the target network address can be secured. In other words, each network device has a multicast address generated from its unique MAC address and the common multicast address, and receives a packet in which a MAC address is set as the common MAC address. Therefore, when a network device wants to obtain MAC addresses of all network devices connected to the network, it can use the common multicast address and the common MAC address.

The MAC address comparator 203 compares the MAC address of the transmitting network device extracted from the received packet with the MAC address of the receiving network device. As described above, when other network devices use the identical multicast address, collisions may occur. Therefore, the receiving network device does not process all the packets received by its multicast address. Rather, the receiving network device processes packets whose MAC address for the receiving network device matches the MAC address unique to the receiving network device, thereby avoiding the collisions.

The packet generator 204 generates a response packet including the MAC address of the receiving network device, the MAC address of the previously transmitting network device, and data to be transmitted to the previously transmitting network device. In the case of one-to-one communication using the present invention, the previously receiving network device transmits the response packet to the previously transmitting network device using a multicast address extracted from the MAC address of the previously transmitting network device.

However, the multicast address of the previously transmitting network device is generated using only the three low order bytes of the MAC address of the previously transmitting network device. Therefore, although the previously transmitting network device has other MAC addresses, the identical multicast address may be used.

FIG. 6 illustrates the structure of a packet according to an embodiment of the present invention. Referring to FIG. 6, to avoid a collision that may occur, the packet includes information such as a MAC address of a transmitting network device 601 and a MAC address of a receiving network device 602 in addition to data 603.

FIG. 7 illustrates the structure of packets transmitted and received according to an embodiment of the present invention. Referring to FIG. 7, a transmitting network device generates a packet 710 including a MAC address of the transmitting network device 601, a MAC address of a receiving network device 602, and data 603, and transmits the packet 710 to the receiving network device 602. Of the packets received, the receiving network device 602 processes the packets having a MAC address that matches the MAC address of the receiving network device 602. The receiving network device 602 discards the packets having a MAC address that does not match the MAC address of the receiving network device 602.

When the receiving network device 602 responds to the packet 710 that is received, it generates a multicast address of the transmitting network device from the MAC address of the transmitting network device 601 included in the packet 710. The receiving network device generates a response packet 720 including a MAC address of the previously responding but now transmitting network device 701, a MAC address of the previously transmitting but now responding network device 702, and data 703, and transmits the response packet 720 to the multicast address of the previously transmitting network device.

Referring back to FIG. 2, the packet transceiver 205 receives a packet from and transmits to other network devices connected to the network.

FIG. 3 is a flow chart illustrating a method of transmitting a packet from a first network device to a second network device according to an embodiment of the present invention. The method includes generating a multicast address of the first network device (Operation S301), designating a MAC address of the second network device (Operation S302), generating a multicast address of the second network device (Operation S303), generating a packet (Operation S304), and transmitting the packet (Operation S305).

Referring to FIG. 3, as described with reference to FIG. 5, the multicast address generator 201 of the first network device generates a multicast address of the first network device from a unique MAC address of the first network device (Operation S301).

The MAC address designator 202 designates a MAC address of the second network device, which is a target device of communication (Operation S302).

The multicast address generator 201 of the first network device, which is the transmitting network device, generates a multicast address of the second network device from the designated MAC address (Operation S303). The generated multicast address of the second network device is an address of the second network device, which is the receiving network device to which the first network device transmits a packet.

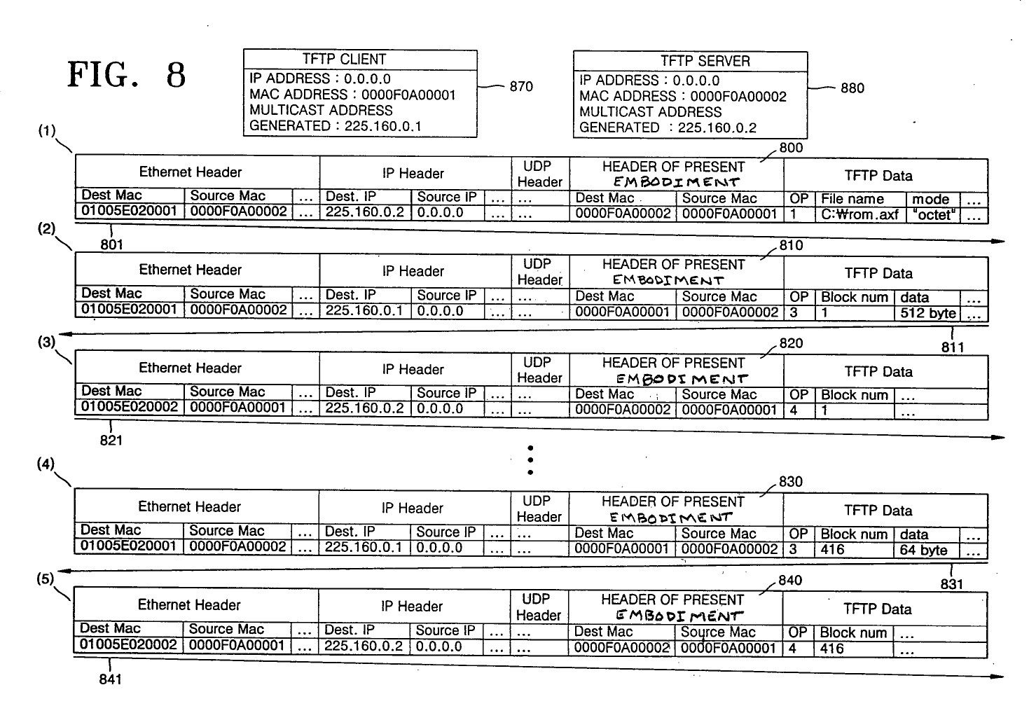

The packet generator 204 of the first network device preferably generates a packet including the MAC address of the first network device, the MAC address of the second network device, and data, as illustrated by FIG. 6. FIG. 6 shows an exemplary packet generated by Operation S304. FIG. 6 illustrates some of the exemplary packets of FIG. 8, which are relevant to an embodiment of the present invention.

The packet transceiver 205 of the first network device transmits the generated packet to the multicast address of the second network device (Operation S305).

FIG. 4 is a flow chart illustrating a method of transmitting a response packet from the second network device to the first network device according to an embodiment of the present invention. The method includes generating a multicast address of the second network device (Operation S401), determining whether a packet is received (Operation S402), determining whether MAC addresses match (Operation S403), processing a packet that is received (Operation S404), determining whether to respond to the received packet (Operation S405), generating a multicast address of the first network device (Operation S406), and generating and transmitting a response packet (Operation S407).

Referring to FIG. 4, the multicast address generator 201 of the second network device generates a multicast address of the second network device from a MAC address unique to the second network device (Operation S401).

The second network device determines whether a packet is received from the first network device (Operation S402).

The MAC address comparator 203 of the second network device extracts the MAC address of the second network device 602 from the received packet and determines whether the extracted MAC address of the second network device included in the received packet matches the MAC address unique to the second network device (Operation S403). If the extracted MAC address of the second network device included in the received packet matches the unique MAC address of the second network device, the packet is processed (Operation S404).

The second network device that received the packet determines whether to reply to the first network device that transmitted the packet (Operation S405). When the second network device determines to reply to the first network device, the MAC address generator 202 of the second network device extracts the MAC address of the first network device from the received packet. Then, the multicast address generator 201 of the second network device generates a multicast address of the first network device from the extracted MAC address of the first network device (Operation S406).

The packet generator 204 of the second network device generates the response packet including the MAC address of the second network device, response data, and the extracted MAC address of the first network device. Then, the response packet thus generated is transmitted to the multicast address of the first network device (Operation S407).

FIG. 8 illustrates the preferable structures of the exemplary packets transmitted between a trivial file transfer protocol (TFTP) server 880 and a TFTP client 870 according to an embodiment of the present invention. Instead of describing all the fields, only fields relevant to an embodiment of the present invention will be described.

Referring to FIG. 8, the IP address of the TFTP client 870 is not designated when the IP address is expressed as 0.0.0.0. The MAC address of the TFTP client 870 is 0000F0A00001 and its multicast address extracted from the MAC address is 225.160.0.1.

The IP address of the TFTP server 880 is also not designated when the IP address is expressed as 0.0.0.0. The MAC address of the TFTP server 880 is 0000F0A00002 and its multicast address extracted from the MAC address is 225.160.0.2.

The TFTP client 870 generates a query packet 1 and transmits the query packet 1 to the TFTP server 880. In other words, the TFTP client 870 generates the query packet 1 by inserting the MAC address (0000F0A00002) of the TFTP server into a “Dest. Mac” field under a “Header of present embodiment” 800 and its MAC address (0000F0A00001) into a “Source MAC,” and transmits the query packet 1 to the multicast address (225.160.0.2) of the TFTP server 880 in a direction 801.

The TFTP server 880 receives the query packet 1 since the MAC address (0000F0A00002) of the TFTP server 880 in the “Dest. Mac” field under the “Header of present embodiment” 800 matches its MAC address, and processes the query packet 1.

The TFTP server 880 generates a multicast address (225.160.0.1) of the TFTP client 870 from the MAC address (0000F0A00001) in the “Source MAC” field under the “Header of present embodiment” included in the query packet 1.

Thereafter, the TFTP server 880 generates a response packet 2 by inserting “0000F0A00002” into the “Source Mac” field and “0000F0A00001” into the “Dest. MAC” field under the “Header of present embodiment” 810.

The response packet 2 is transmitted to the multicast address (225.160.0.1) of the TFTP client 870 in a direction 811.

This process is repeated to generate packets 3, 4, and 5 until a file is completely downloaded. The “Source MAC” field and the “Dest. MAC” field under headers of the present invention 820, 830, and 840 respectively corresponding to the packets 3, 4, and 5 are changed depending on directions 821, 831, and 841 in which the packets 3, 4, 5 are transmitted and received.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A communication method using a first multicast address and a second multicast address by generating the first multicast address using a first media access control address unique to a first network device connected to a network and the second multicast address using a second media access control address unique to a second network device connected to the network, the method comprising:
generating the first multicast address from the first media access control address unique to the first network device;
generating the second multicast address from the second media access control address unique to the second network device;
generating a packet by the first network device and transmitting the packet to the second network device with the second multicast address; and
generating a response packet by the second network device that receives the packet and transmitting the response packet to the first network device with the first multicast address.

2. The method of claim 1, wherein the packet comprises at least the first media access control address, the second media access control address, and the second multicast address.

3. The method of claim 1, wherein the response packet comprises at least the first media access control address, the second media access control address, and the first multicast address.

4. The method of claim 1, wherein the generation of a response packet by the second network device that receives the packet and the transmission of the response packet by the second network device to the first network device with the first multicast address comprises:
determining whether the second media access control address included in the received packet matches the second media access control address unique to the second network device;
processing the received packet when the second media access control address included in the received packet matches the second media access control address unique to the second network device; and
generating the response packet and transmitting the response packet to the first network device with the first multicast address.

5. The method of claim 4, wherein the determination of whether the second media access control address included in the received packet matches the second media access control address unique to the second network device comprises:
extracting the second media access control address from the received packet; and
determining whether the extracted second media access control address matches the second media access control address unique to the second network device.

6. The method of claim 1, wherein the generation of a packet by the first network device and transmission of the packet to the second network device with the second multicast address comprises:
generating the packet by the first network device and transmitting the packet to the second network device with the second multicast address;
determining whether the first media access control address included in the response packet received from the second network device matches the first media access control address unique to the first network device; and
processing the response packet when the first media access control address included in the received response packet matches the first media access control address unique to the first network device.

7. The method of claim 6, wherein the determination of whether the first media access control address included in the response packet received from the second network device matches the first media access control address unique to the first network device comprises:
extracting the first media access control address from the received response packet; and
determining whether the extracted first media access control address matches the first media access control address unique to the first network device.

8. A communication apparatus using a first multicast address and a second multicast address by generating the first multicast address using a first media access control address unique to a first network device connected to a network and the second multicast address using a second media access control address unique to a second network device connected to the network, the method comprising:
the first network device generating a packet and transmitting the packet to the second network device with the second multicast address; and
the second network device receiving the packet and transmitting the response packet to the first network device with the first multicast address.

9. The apparatus of claim 8, wherein the first network device comprises:
a media access control address designator designating the second media access control address unique to the second network device;
a multicast address generator generating the second multicast address of the second network device that receives the packet;
a packet generator comprising at least the first media access control address, the second media access control address, and the second multicast address;
a packet transceiver transmitting the packet generated by the packet generator to the second network device with the second multicast address and receiving the response packet transmitted from the second network device; and
a media access control comparator extracting the first media access control address from the received response packet and comparing the extracted first media access control address with the first media access control address unique to the first network device to determine whether they match.

10. The apparatus of claim 9, wherein the multicast address generator generates the second multicast address from the second media access control address.

11. The apparatus of claim 8, wherein the second network device comprises:
a media access control address designator designating a first media access address unique to the first network device;
a multicast address generator generating the first multicast address of the first network device receiving the response packet;
a packet generator comprising at least the first media access control address, the second media access control address, and the first multicast address;
a packet transceiver transmitting the packet generated by the packet generator to the second network device with the second multicast address and receiving the response packet transmitted from the second network device; and
a media access control comparator extracting the second media access control address from the received packet and comparing the extracted second media access control address with the second media access control address unique to the second network device to determine whether they match.

12. The apparatus of claim 11, wherein the multicast address generator generates the second multicast address from the second media access control address.
